(19) United States
(12) Patent Application Publication
(10) Pub. No.: US 2026/0326026 A1
(43) Pub. Date: Oct. 22, 2026

(54) DEVICE AND METHOD FOR DRYING A COMPRESSED GAS ORIGINATING FROM A COMPRESSOR

(71) Applicant: ATLAS COPCO AIRPOWER, NAAMLOZE VENNOOTSCHAP, Wilrijk (BE)

(72) Inventor: Danny VERTRIEST, Wilrijk (BE)

(73) Assignee: ATLAS COPCO AIRPOWER, NAAMLOZE VENNOOTSCHAP, Wilrijk (BE)

(21) Appl. No.: 19/103,460

(22) PCT Filed: Jul. 27, 2023
(86) PCT No.: PCT/IB2023/057627

§ 371 Date: Feb. 12, 2025

(30) Foreign Application Priority Data
Aug. 23, 2022 (BE) BE2022/5665

(51) Int. Cl. B01D 53/26; B01D 53/04

(52) U.S. Cl. CPC B01D 53/261; B01D 53/0438; B01D 53/0446; B01D 53/0462; B01D 53/265; B01D 2257/80; B01D 2259/40003

(57) ABSTRACT

A device for drying a gas, wet compressed by a compressor, including a supply, adsorption dryer, a cooler, a water separator, a drain and lines and valves. The device further includes an ejector-manifold comprising a main channel connecting to the supply, and suction channels connecting to the absorption dryers. The lines and valves are configured to mix, with the ejector-manifold, a portion of dried compressed gas via the suction channels during a drying phase with wet compressed gas at the supply via the main channel.

### TECHNICAL FIELD

The present invention relates to a device and method for drying a compressed gas, and more particularly to a device and method for drying a compressed gas from a compressor.

### STATE OF THE ART

Compressed gas, for example air, originating from the compressor usually has a high moisture content. This moisture can be detrimental to the line network and is undesirable in certain applications. Therefore, as is known, there is a need for a device for drying a compressed gas.

In BE1010132A3 a method and device for drying a gas, compressed by a compressor, is disclosed. Here, compressed gas is dried by passing it through a drying agent, while at the same time already used drying agent is regenerated by passing through it a portion of the compressed gas supplied by the compressor.

In BE1027364A1 a similar method and device is disclosed, in which a heating means and venturi ejector are provided to exchange heat between the regeneration gas and the incoming compressed gas from the compressor to shorten the time of regeneration.

Disadvantages of these known methods and devices are that either regeneration times take too long, and/or that the complexity of the entire installation increases, together with the technical control aspects to control the installation. In other words, a compromise must always be made between the economic interests of short regeneration times on the one hand, and technical optimization by reducing the complexity of the installation on the other hand.

It is therefore an object of the present invention to provide a device and method which overcomes one or more of the described disadvantages of solutions from the state of the art. More specifically, it is an object of the present invention to provide a device and method which leads to shorter drying agent regeneration times without making the device and associated method unnecessarily complex.

### SUMMARY OF THE INVENTION

According to the present invention, the object identified above is achieved by providing, according to a first aspect of the invention, a device according to claim 1, the device consisting of a supply, suitable for supplying the wet compressed gas, and a first and a second adsorption dryer, suitable to be filled with a drying agent, and a cooler and a water separator, a drain, suitable for discharging dried compressed gas, a set of lines and valves, wherein the set of lines and valves is configured to successively pass the wet compressed gas, in a first and second regeneration phase, respectively, from the supply to the first and second adsorption dryer, respectively, the cooler and the water separator, the second and first adsorption dryer, respectively, and the drain; and further configured to successively pass the wet compressed gas, in a first and second drying phase, respectively, from the supply to the cooler and the water separator, the second and first adsorption dryer, respectively, and the drain, CHARACTERISED IN THAT the device further comprises a ejector-manifold comprising a main channel and first and second suction channel, the main channel connecting to the supply, and the first and second suction channel, respectively, connecting to the first and second adsorption dryer, respectively, and wherein the set of lines and valves is further configured to mix, with the ejector-manifold, a portion of dried compressed gas via the suction channels during the drying phase with the wet compressed gas at the supply via the main channel.

The device comprises means as known in the state of the art, such as two adsorption dryers, a supply and a drain, and a cooling installation comprising a cooler and a water separator. Furthermore, the device comprises a set of lines and valves which connect the various means or components with each other, and which can have different functions performed by the position of the valves, also referred to hereinafter as ventils. As a result, the device can be used for conducting both regeneration phases and drying phases.

According to a regeneration phase as known in the state of the art, hot and wet compressed gas, directly originating from a compressor, is passed through an adsorption dryer to heat up the drying agent present and thus extract moisture, while the other adsorption dryer is used for drying the wet compressed gas from the compressor, after it has been cooled and condensate has been withdrawn from it. The regeneration and drying phases can be alternated between the adsorption dryers to guarantee the continuity of the dryer.

To meet the drawbacks known in the state of the art as already listed, the device further comprises an ejector-manifold.

An ejector-manifold comprises a main channel through which a fluid can flow and two suction channels that are in fluid-mechanical communication with the main channel. By allowing a fluid to flow through the main channel, an negative pressure is created at the suction channels, as a result of which a fluid present in the first and/or second suction channel, or in lines connected thereto, is sucked into the main channel by the created negative pressure.

The ejector-manifold is configured and connected such that wet compressed gas, originating from a compressor, is allowed to flow through the main channel. The two suction channels are each connected to a connection of a respective adsorption dryer. Due to the negative pressure principle just explained, in combination with the arrangement and position of the valves, a portion of the compressed gas that has already been cooled and has passed through an adsorption dryer will be mixed with wet and hot compressed gas directly originating from the compressor. This is achieved by positioning the set of valves such that this portion can be mixed with the wet and hot compressed gas, while the other portion, hence the portion that is not mixed, is passed to the drain.

The innovative aspect of the use of a single ejector-manifold in a device for drying a gas, wet compressed by a compressor, can be positioned in the device in two distinct configurations.

According to a first manner, the ejector-manifold can be connected to the adsorption dryers such that, in the two drying phases, the portion that will be mixed via the suction channels, is successively passed through the cooler and water separator and through the second adsorption dryer for the first drying phase and through the first adsorption dryer for the second drying stage, respectively. This arrangement will hereinafter be referred to as the first configuration.

According to a second manner, the ejector-manifold can be connected to the adsorption dryers such that, in the second drying phases, the portion that will be mixed via the suction channels is successively passed through the cooler and water separator and through the first adsorption dryer for the first drying phase and through the second adsorption dryer for the second drying stage, respectively. This arrangement will hereinafter be referred to as the second configuration.

According to the first configuration, for the regeneration stages, the wet compressed gas will be successively passed, concerning the first regeneration stage, to the first adsorption dryer, the first suction channel, and the cooler and the water separator, and concerning the second regeneration stage, to the second adsorption dryer, the second suction channel, and the cooler and the water separator. In other words, the positions of the valves or ventils are set, for the regeneration phases, such that the main channel of the ejector-manifold is closed off.

According to the second configuration, for the regeneration stages, the wet compressed gas will be passed, concerning the first regeneration stage, to the first suction channel, the first adsorption dryer, the cooler and the water separator, the second adsorption dryer, and finally the drain, while concerning the second regeneration stage, the wet compressed gas is passed to the second suction channel, the second adsorption dryer, the cooler and the water separator, the first adsorption dryer, and finally the drain. Similar to the first configuration, the main channel of the ejector-manifold is also closed off.

The portion of the dried compressed gas that will be mixed with the wet and hot compressed gas amounts fifteen to twenty five percent of the dried compressed gas, and preferably twenty percent thereof. Stated differently, the volume or mass of wet and hot compressed gas at the input corresponds to one hundred percent volume or mass, and thereof, fifteen to twenty-five percent, and preferably twenty percent, will circulate internally and one hundred percent will flow out through the drain. However, it should be noted that other ratios are not excluded, depending on the load of the dryer.

A first advantage of the device described above for drying a wet compressed gas originating from a compressor is that only a single cooler and water separator is required, due to the use of an ejector-manifold. This not only makes the device more energy-efficient compared to known devices, but also less expensive and less complex to assemble. An additional component such as a cooler and water separator, as known in the state of the art, makes the configuration of the set of lines and valves more complex, which means that the innovative device described above is indeed less complicated to assemble. This further reduces the risk of making mistakes during the production process of the drying device.

Both according to the first and second configuration, the adsorption dryers, and more specifically the drying agent present, can be generated with hot compressed gas.

In the first configuration, during the drying phase, the adsorption dryer through which the portion of the derived dried and cooled compressed gas flows, can be further generated, which is an additional advantage over the state of the art device. For the first drying phase, this corresponds to the first adsorption dryer, while for the second drying phase, this corresponds to the second adsorption dryer. This is possible because the portion that is diverted is dry and cooled gas, which indeed ensures further drying of drying agent, present in the respective adsorption dryer.

Another advantage for both configurations is that the regeneration and drying phases do not depend on the heat present in the hot compressed gas at partial load or low load of the compressor.

According to an embodiment, the device further comprises a measurement module configured to determine a regeneration status of the adsorption dryers.

The measuring module is, for example, a dew point meter, and/or a set of a pressure, temperature and differential pressure meter. Via such a set, the dew point can be determined indirectly.

By determining the regeneration status of the adsorption dryers, it can then be determined when to switch between the different regeneration and drying phases. To achieve this, the device may further comprise a control module which will control the set of valves or ventils based on the determined or derived regeneration states. Alter-natively, the control module may also be external to the device.

According to a second aspect of the invention, there is provided a method for drying a gas, compressed by a compressor, by means of a first and a second adsorption dryer, respectively, each comprising a drying agent according to claim 8, the method comprising alternately performing a first and second regeneration phase, respectively, in combination with a first and second drying phase, respectively, the first and second regeneration phase, respectively, sequentially comprising the steps of regenerating the first and second adsorption dryer, respectively, by means of the compressed gas, cooling and separating condensate from the compressed gas, drying of the compressed gas by means of the second and first adsorption dryer, respectively, and the drying phase sequentially comprising the steps of cooling the compressed gas and separating condensate thereby obtaining cooled compressed gas, and drying the cooled compressed gas by means of the second and first adsorption dryer, respectively, thereby obtaining cooled dried compressed gas, CHARACTERISED IN THAT the drying phase further, prior to the cooling step, comprises the steps of passing a portion of the cooled dried compressed gas through the first and second adsorption dryer, respectively, mixing the compressed gas with the portion of the cooled dried compressed gas.

This method is applicable to the device according to the first configuration as described above, in which case the listed advantages also apply.

According to a third aspect of the invention, there is provided a method for drying a gas, compressed by a compressor, by means of a first and a second adsorption dryer, respectively, each comprising a drying agent according to claim 9, the method comprising alternately performing a first and second regeneration phase, respectively, in combination with a first and second drying phase, respectively, the first and second regeneration phase, sequentially comprising the steps of regenerating the first and second adsorption dryer, respectively, by means of the compressed gas, cooling and separating condensate from the compressed gas, drying of the compressed gas by means of the second and first adsorption dryer, respectively; and the drying phase sequentially comprising the steps of cooling the compressed gas, thereby obtaining cooled compressed gas, and drying the cooled compressed gas by means of the second and first adsorption dryer, respectively, thereby obtaining cooled dried compressed gas, CHARACTERISED IN THAT the drying phase is further preceded to the step of cooling, includes the steps of passing a portion of the cooled compressed gas through the first and second adsorption dryer, respectively, mixing the compressed gas with the portion of the cooled compressed gas.

This method is applicable to the device according to the second configuration as described above, in which case the listed advantages also apply.

According to an embodiment of both the second and third aspects of the invention, there is further provided the step of regenerating the drying agent of the first and second adsorption dryer, respectively, using the portion of the gas.

This corresponds to the drying phases of the device according to the first aspect of the invention, wherein the regeneration of the drying agent can thus take place during the drying phases by allowing cooled and dehumidified gas to be passed through the respective adsorption dryers.

According to an embodiment of both the second and third aspects of the invention, there is further provided the step of determining a regeneration status of the first and/or second adsorption dryer, and wherein alternately performing the first and second regeneration phases, respectively, in combination with the first and second drying phase, respectively, is based on the regeneration status.

Alternately performing the regeneration phases and the drying phases is then further effected by the targeted actuation of the valves or ventils such that their respective position is changed between open and closed, and vice versa.

According to a fourth aspect of the invention, there is provided an ejector-manifold, suitable for a device according to the first aspect, and/or suitable for mixing compressed gas with a portion of cooled dried compressed gas by a method according to the second and/or third aspect of the invention.

According to a fifth aspect, the use of the ejector-manifold according to the fourth aspect is disclosed.

According to a sixth aspect, a compressor installation comprising a compressor with an outlet connected to the inlet of a device according to the first aspect is disclosed.

### BRIEF DESCRIPTION OF THE DRAWINGS

The invention will be further illustrated with reference to the figures, in which

FIGS. 1 to 4 illustrate a direction for drying a compressed gas according to the first configuration and associated method; and

FIGS. 4 to 8 illustrate a device for drying a compressed gas according to the second configuration and associated method; and

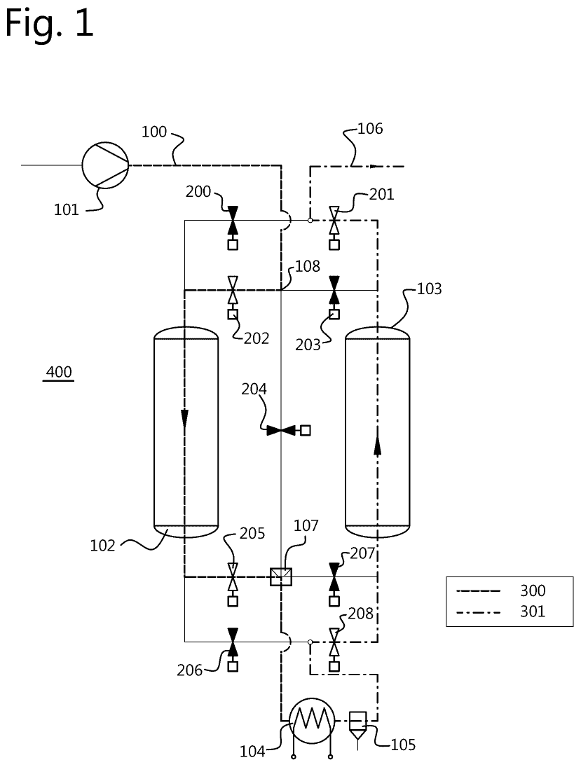

FIG. 1 illustrates a first regeneration stage according to the first configuration of the device for drying a compressed gas, and associated method; and

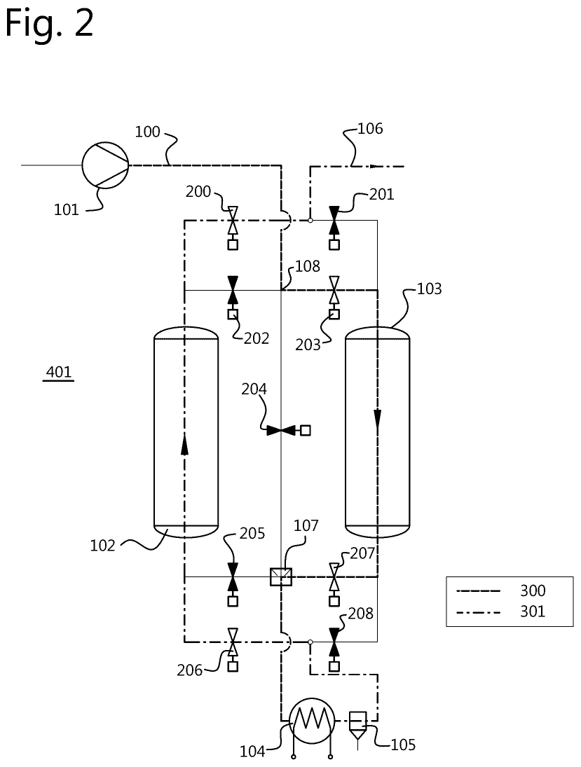

FIG. 2 illustrates a second regeneration stage according to the first configuration of the device for drying a compressed gas and associated method; and

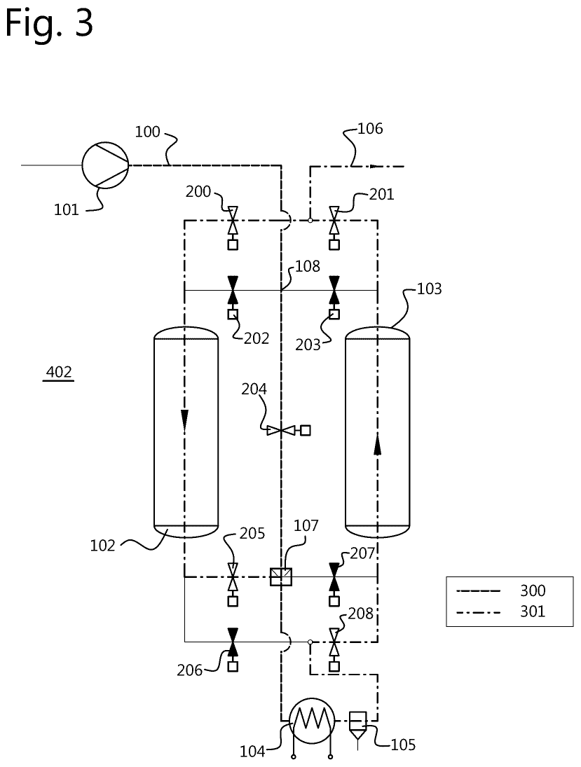

FIG. 3 illustrates a first cooling and drying stage according to the first configuration of the device for drying a compressed gas and associated method; and

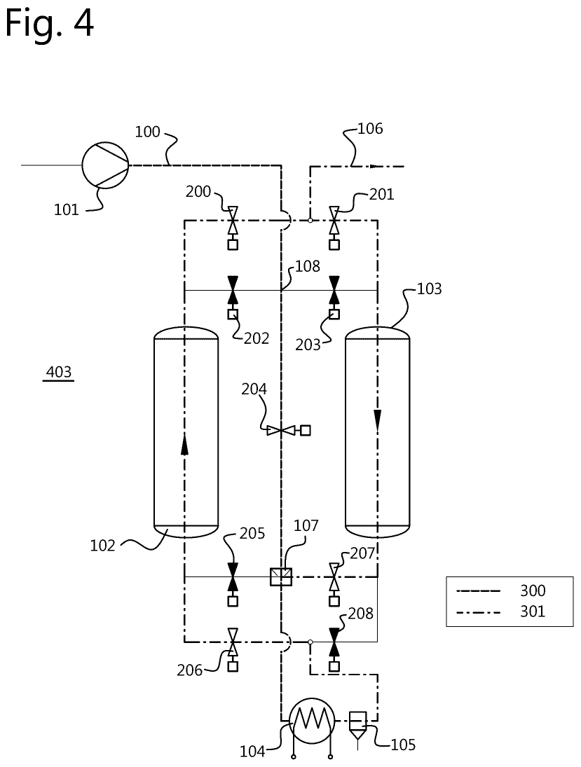

FIG. 4 illustrates a second cooling and drying stage according to the first configuration of the device for drying a compressed gas and associated method; and

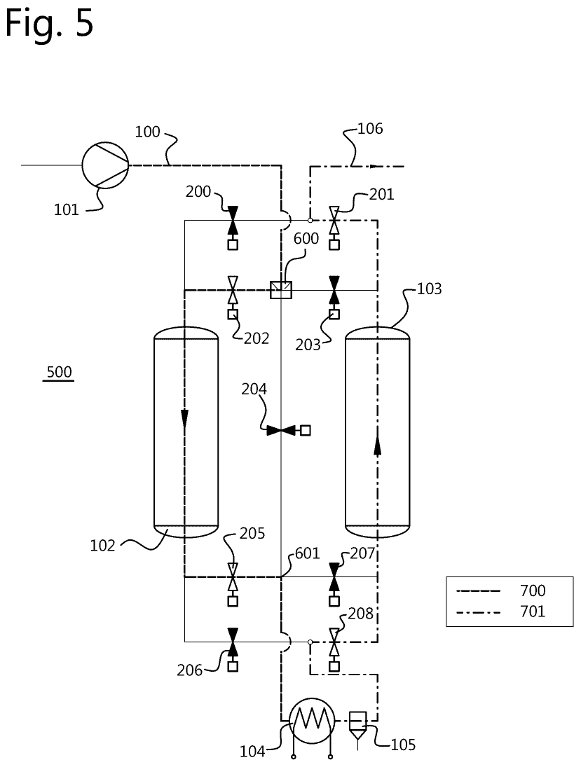

FIG. 5 illustrates a first regeneration stage according to the second configuration of the device for drying a compressed gas and associated method; and

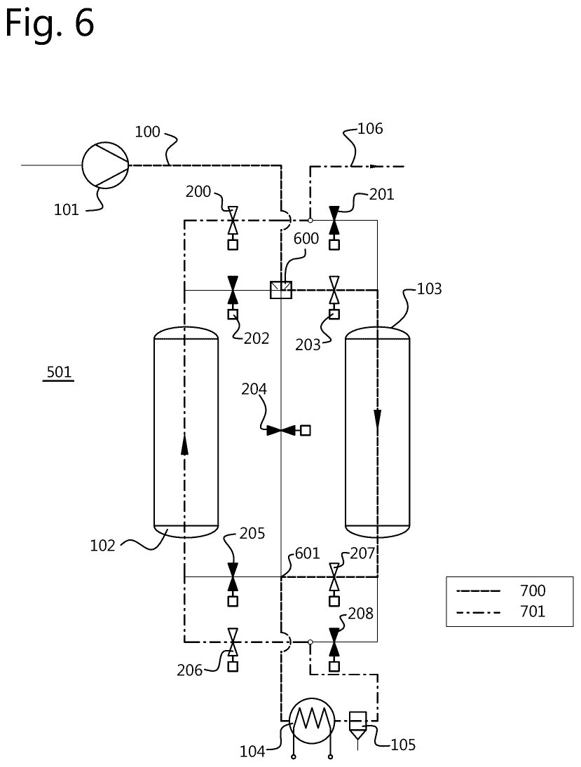

FIG. 6 illustrates a second regeneration stage according to the second configuration of the device for drying a compressed gas and associated method; and

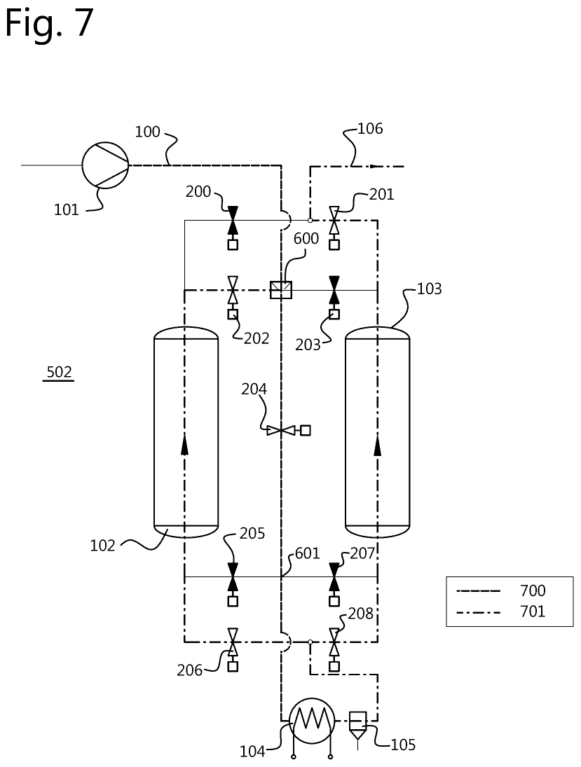

FIG. 7 illustrates a first cooling stage according to the second configuration of the device for drying a compressed gas and associated method; and

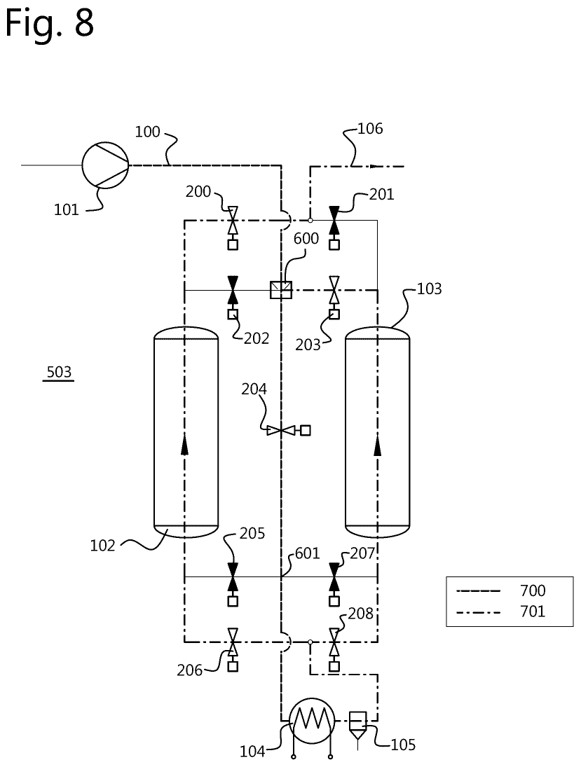

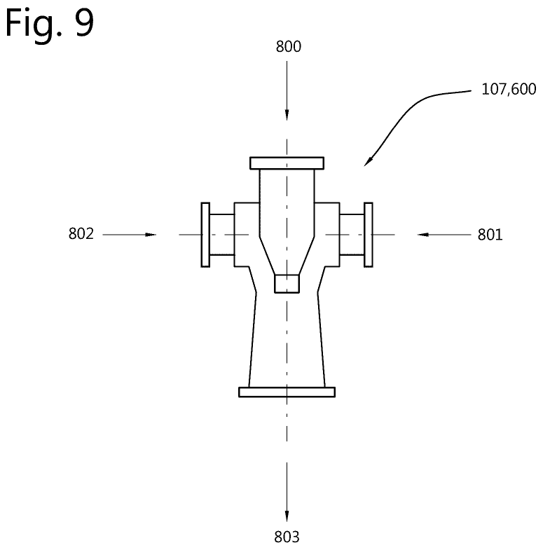

FIG. 8 illustrates a second cooling stage according to the second configuration of the device for drying a compressed gas and associated method; and

FIG. 9 illustrates an ejector-manifold, suitable for the device as illustrated in the previous figures.

### DETAILED DESCRIPTION OF THE EMBODIMENTS

The present invention will be described with respect to certain embodiments and with reference to certain drawings, but the invention is not limited thereto and is defined only by the claims. The drawings described are only schematic and non-limiting. In the drawings, the size of certain elements may be exaggerated and not drawn to scale for illustrative purposes. The dimensions and relative dimensions do not necessarily correspond to actual practice of the invention.

In addition, the terms first, second, third and the like are used in the description and in the claims to distinguish between similar elements and not necessarily to describe a sequential or chronological order. The terms are interchangeable under appropriate circumstances and the embodiments of the invention may be used in sequences other than those described or illustrated herein.

In addition, the terms top, bottom, over, under and the like are used in the specification and claims for illustrative purposes and not necessarily to describe relative positions. The terms thus used are interchangeable under appropriate circumstances and the embodiments of the invention described herein may be used in orientations other than those described or illustrated herein.

Furthermore, the various embodiments, while referred to as “preferred embodiments”, are to be construed as exemplifying how the invention may be practiced rather than as limiting the scope of the invention.

The term “comprising”, used in the claims, is not to be construed as limited to the means or steps set forth below; the term does not exclude other elements or steps. The term should be interpreted as specifying the presence of said features, elements, steps or components referred to, but does not exclude the presence or addition of one or more other features, elements, steps or components, or groups thereof. The scope of the expression “a device comprising means A and B” should therefore not be limited to devices consisting only of components A and B. The meaning is that, with respect to the present invention, only components A and B of the device are recited, and the claim is further construed to include equivalents of these components as well.

FIGS. 1 to 8 illustrate a direction for drying a compressed gas. More specifically, FIGS. 1 to 4 illustrate the device according to the first configuration, and FIGS. 5 to 8 illustrate the device according to the second configuration.

With reference to FIG. 1 and FIG. 4, the various components of the device according to the first configuration will be discussed. It is thus to be understood that these components or parts are also present in FIGS. 2 to 4. Where there is a difference between the illustrated devices in the various figures, an explanation will be given.

In FIG. 1, a device is illustrated for drying a compressed gas from a compressor 101. However, it should be understood that the compressor 101 itself need not form part of the device itself.

The device has a supply connected to point 108. From point 108, three lines depart to three valves, respectively, being valves 202, 203, and 204. Second adsorption dryers 102 and 103 are also present. Adsorption dryer 102 is arranged between valve 202 and valve 205. Adsorption dryer 103 is arranged between valve 203 and 207. Furthermore, adsorption dryer 102 is also arranged between valve 200 and valve 206. Adsorption dryer 103 in turn is arranged further between valve 201 and valve 208.

In other words, an adsorption dryer has two connections for a gas to flow through. For each adsorption dryer in the device, two valves are then provided per connection. For the adsorption dryer 102, these are valves 200 and 202 on one connection, and valves 205 and 206 on the other connection. For the adsorption dryer 103, these are valves 201 and 203 on one connection, and valves 207 and 208 on the other connection.

Furthermore, the device illustrated in FIGS. 1 to 4, comprises an ejector-manifold 107. This ejector-manifold 107 is also further illustrated in FIG. 9.

The ejector-manifold 107 as illustrated in FIG. 9 is also suitable for the device according to the second configuration, illustrated in FIGS. 5 to 8, as will be further explained. The ejector-manifold 107 comprises a main channel with inlet 800. This main channel 800 continues to outlet 803. It should further be noted that, at outlet 803, the two suction channels 801 and 802 also converge.

The operation of the ejector-manifold 107 is as follows. By allowing a fluid, hence a gas or a liquid, to flow through the inlet 800 to the outlet 803, which corresponds to the main channel of the ejector-manifold 107, a negative pressure is created at the suction channels 801 and 802. As a result, a fluid present in a line connected to the suction channels 801 and 802, will be sucked in. The fluid in main channel 800 is then mixed with fluids in the line connected to suction channels 801 through 802 and flows out through outlet 802.

The ejector-manifold 107 is connected such that the main channel with inlet 800 is connected to valve 204, which in turn connects to point 108, and then on to the supply 100. Thus, this arrangement allows the hot and wet compressed gas, originating from the compressor 101, to flow through the main channel of the ejector-manifold 107 when the set of valves are set as will be further explained.

The suction channels of the ejector-manifold 107 are connected to valves 205 and 207, respectively. The outlet of the ejector-manifold 107, hence at the confluence of the main channel and the two suction channels, is connected to a cooler 104. After the cooler, there is a water separator 105. After the water separator, there is a branch-off to valves 206 and 208.

Finally, the device has a drain 106, branched off between the valves 200 and 201.

The device described above with components, parts, lines and set of lines is, besides in FIG. 1, also illustrated in FIGS. 2 to 4.

The colour of the valves illustrates a possible position between closed and open. Thus, in FIG. 1, valves 200, 203, 204, 206, and 207 are illustrated with a full filled black area, while valves 201, 202, 205, and 208 are illustrated with an empty white area. The difference between the two illustrations is that a filled black surface illustrates a closed valve, while an empty white surface illustrates an open valve.

In FIG. 1, the illustrations of the valves therefore indicate closed valves 200, 203, 204, 206, and 207, and open valves 201, 202, 205, and 208. In FIG. 2, an opposite situation is shown, being open valves 200, 203, 206, and 207, and closed valves 201, 202, 205 and 208. In both situations, valve 204 remains closed.

The different regeneration and drying phases for the first configuration will now be discussed further. In FIGS. 1 to 4, hot and wet compressed gas, originating directly from the compressor 101, is illustrated by the lines marked as line 300, and cooled and dehumidified compressed gas by the lines marked as line 301.

FIG. 1 illustrates a first regeneration phase 400 for the first configuration of the device. Herein, valves 201, 202, 205 and 208 are open, and valves 200, 203, 204, 206 and 207 are closed. Wet and hot compressed gas 300 from the compressor 101 is passed through the input 100 to the first adsorption dryer 102 to regenerate the drying agent contained therein. The gas then flows via valve 205, and via a suction line from the ejector-manifold 107 to the cooler 104 and water separator 105. Subsequently, this cooled and dehumidified gas 301 is further dried by adsorption dryer 103 and passed to the drain 106.

In FIG. 2, the second regeneration phase 401 for the first configuration of the device is illustrated. Here too, valve 204 remains closed, such that the main channel at the inlet 800 of the ejector-manifold 107 remains closed. Through the open valves 200, 203, 206, and 207, and other closed valves 201, 202, 205, and 208, the wet and hot compressed gas 300 is first passed through the second adsorption dryer 103 for regeneration of the drying agent present. After cooling and dehumidification 301, the gas is passed to the first adsorption dryer for further drying.

FIG. 3 illustrates a first drying phase 402 of the first configuration of the device, and FIG. 4 illustrates a second drying phase of this first configuration. It should be noted here that, for both phases, valve 204 is open and valves 202 and 203 are closed. This setting will cause the wet and hot compressed gas 300 to flow through the main channel 107 of the ejector-manifold 107 past the inlet 800. As a result, an negative pressure is created on both suction channels 801, 802. However, because valve 207 is closed, only the gas on the side of valve 205 is sucked in.

The wet and hot compressed gas 300 is cooled 104, the water is separated-off 105 and then passed to adsorption dryer 103 for further drying. Subsequently, a portion of the dried gas 301 is diverted to the first adsorption dryer 102 and another portion to the drain 106. This is illustrated by the branch point between valves 200 and 201. The portion that is diverted thus flows through valve 200 to the adsorption dryer 102, through valve 205, to then be sucked through the suction channel of the ejector-manifold 107, where it is mixed with the hot and wet compressed gas 300 coming from the main channel. By passing the portion of the dried gas 301 through the first adsorption dryer 102, the drying agent contained therein can be further generated.

In FIG. 4, a similar situation is illustrated, this time illustrating the second drying phase 403 of the first configuration of the device. Herein, the dried gas 301 will first be passed to the first adsorption dryer 102, and a portion will be diverted to the second adsorption dryer 103 for further regeneration of the drying agent present, similar to the first drying phase 402.

The second configuration of the device will now be further illustrated with reference to FIGS. 5 to 8.

As can be seen in FIG. 5, the connection of the ejector-manifold in the second configuration is different than for the first configuration. The ejector-manifold 600 is again connected by the main channel to the supply 100, but this time in front of valve 204 from a fluid-mechanical point of view. The suction ducts 801, 802 of the ejector-manifold 600 are connected to valves 202 and 203. Further, there is point 601 where three lines converge, being one coming from valve 204, one coming from valve 205, and one coming from valve 207. As for the other components and parts, there is a similar operation as for the first configuration, and as will be further explained.

FIG. 5 illustrates the first regeneration stage 500 for the second configuration of the device. Valves 200, 203, 204, 206, and 207 are closed, and valves 201, 202, 205, and 208 are open.

The hot and compressed gas, now illustrated by line with marking such as line 700, will now be passed through the main channel 800 of the ejector-manifold 600 through the suction channel to the first adsorption dryer 102. It is then passed to the cooler 104 and water separator 105, and the cooled gas, further illustrated by the lines such as marking 701, is passed to the adsorption dryer 103 for further drying and then to the drain 106.

In FIG. 6, the second regeneration stage 501 of the second configuration is illustrated, wherein the hot gas 700 is passed to the second adsorption dryer 103 for regeneration of the drying agent present, and the cooled gas 701 to the first adsorption dryer 102 for further drying before being passed to the drain 106.

FIG. 7 illustrates the first drying stage 502 and FIG. 8 the second drying phase 503 for the second configuration of the device.

The difference between the first and second configuration, due to the arrangement of the ejector-manifold 600, is that in the second configuration the cooled gas 701 is diverted immediately after the cooler 104 and water separator 105, while in the first configuration, this only takes place after first passing through an adsorption dryer. In the second configuration, each adsorption dryer 102, 103 will never pass more than one hundred percent of the incoming gas supply. In the first configuration, up to one hundred and twenty-five percent of the incoming volume or mass can flow through an adsorption dryer 102, 103 and this should be accounted for in the design.

1-15. (canceled)

16. A device for drying a gas, wet compressed by a compressor, the device comprising:
a supply, suitable for supplying the wet compressed gas; and
a first and a second adsorption dryer, suitable to be filled with a drying agent; and
a cooler and a water separator;
a drain, suitable for discharging dried compressed gas;
a set of lines and valves;
the first adsorption dryer is arranged between a third valve and a sixth valve,
the first adsorption dryer is also arranged between a first valve and a seventh valve
the third adsorption dryer is arranged between a fourth valve and an eighth valve
the third adsorption dryer also is arranged further between a second valve and a ninth valve,
wherein the set of lines and valves is configured to successively pass the wet compressed gas, in a first and second regeneration phase, respectively, from the supply to the first and second adsorption dryer, respectively, the cooler and the water separator, the second and first adsorption dryer, respectively, and the drain; and further configured to successively pass the wet compressed gas, in a first and second drying phase respectively, from the supply to the cooler and the water separator, the second and first adsorption dryer, respectively, and the drain;
wherein the device further comprises an ejector-manifold comprising a main channel and a first and second suction channel, the main channel connecting to the supply, and the first and second, respectively, suction channel connecting to the first and second adsorption dryer, respectively, the suction channels of the ejector-manifold are connected to the sixth valve and the eighth valve, respectively, the outlet of the ejector-manifold is connected to the cooler, and wherein the set of lines and valves is further configured to mix, with the ejector-manifold, a portion of dried compressed gas via the suction channels during the drying phase with the wet compressed gas at the supply via the main channel; and
wherein the first and second suction channel, respectively, connect to the first and second adsorption dryer, respectively, such that during the first and second drying phase, respectively, the portion is successively passed through the cooler and the water separator, the second and the first adsorption dryer, respectively through the cooler and the water separator, the first and the second adsorption dryer.

17. The device according to claim 16, wherein the set of lines and valves is further configured to successively pass the wet compressed gas in the first and second regeneration phases, respectively, to the first and second adsorption dryer, respectively, the first and second suction channel respectively, the cooler and water separator, the second and first adsorption dryer, respectively, and the drain.

18. The device according to claim 16, wherein the first and second suction channel, respectively, connect to the first and second adsorption dryer, respectively, such that during the first and second drying phase, respectively, the portion is successively passed through the cooler and the water separator and the first adsorption dryer, respectively through the cooler and the water separator and the second adsorption dryer.

19. The device according to claim 18, wherein the set of lines and valves is further configured in the first and second regeneration phase, respectively, to successively pass the wet compressed gas to the first and second suction channel, respectively, the first and second adsorption dryer, respectively, the cooler and water separator, the second and first adsorption dryer, respectively, and the drain.

20. The device according to claim 16, further comprising a measuring module, configured for determining a regeneration status of the first and/or second adsorption dryer.

21. The device according to claim 20, further comprising a control module configured to control and drive the set of valves based on regeneration status.

22. A method for drying a gas, compressed by a compressor, by means of a first and a second adsorption dryer, respectively, each comprising a drying agent, the method comprising alternately performing a first and second regeneration phase, respectively, in combination with a first and second drying phase, respectively, the first and second regeneration phase, respectively, sequentially comprising the steps of:
regenerating the first and second adsorption dryer, respectively, by means of the compressed gas;
cooling and separating condensate from the compressed gas;
drying the compressed gas by means of the second and first adsorption dryer, respectively;
and the drying phase sequentially comprising the steps of:
cooling the compressed gas and separating condensate thereby obtaining cooled compressed gas; and
drying the cooled compressed gas by means of the second and first adsorption dryer, respectively, thereby obtaining cooled dried compressed gas;
wherein the drying phase further precedes the step of cooling, comprising the steps of:
passing a portion of the cooled dried compressed gas through the first and second adsorption dryer, respectively;
mixing the compressed gas with the portion of the cooled dried compressed gas.

23. A method for drying a gas, compressed by a compressor, by means of a first and a second adsorption dryer, respectively, each comprising a drying agent, the method comprising alternately passing a first and a second regeneration phase, respectively, in combination with a first and second drying phase, respectively, the first and second regeneration phase, respectively, successively comprising the steps of:
regenerating the first and second adsorption dryer, respectively, by means of the compressed gas;
cooling and separating condensate from the compressed gas;
drying the compressed gas by means of the second and first adsorption dryer, respectively;
and the drying phase successively comprising the steps of:
cooling the compressed gas thereby obtaining cooled compressed gas; and
drying the cooled compressed gas by means of the second and first adsorption dryer, respectively, thereby obtaining cooled dried compressed gas;
wherein the drying phase further precedes the step of cooling, comprising the steps of:
passing a portion of the cooled compressed gas through the first and second adsorption dryer respectively;
mixing the compressed gas with the portion of the cooled compressed gas.

24. The method according to claim 22, wherein the drying phase further comprises the step of:
regenerating the drying agent of the first and second adsorption dryer, respectively, using the portion of the gas.

25. The method according to claim 22, wherein regenerating through the regeneration stage comprises heating the drying agent using heat of compression of the compressed gas.

26. The method according to claim 22, further comprising the step of:
determining a regeneration status of the first and/or second adsorption dryer; and wherein alternating conducting the first and second regeneration phases, respectively, in combination with the first and second drying phase, respectively, is based on the regeneration status.

27. An ejector-manifold for a device according to claim 16, the ejector-manifold comprising a main channel and first and second suction channel, the main channel connecting to a supply, and the first and second, respectively, suction channel connecting to a first and second adsorption dryer, respectively, the suction channels of the ejector-manifold are connected to a sixth valve and a eighth valve, respectively, an outlet of the ejector-manifold is connected to a cooler, and wherein a set of lines and valves is further configured to mix, with the ejector-manifold, a portion of dried compressed gas via the suction channels during a drying phase with wet compressed gas at the supply via the main channel; and
wherein the first and second suction channel, respectively, connect to the first and second adsorption dryer, respectively, such that during a first and second drying phase, respectively, the portion is successively passed through the cooler and a water separator, the second and the first adsorption dryer, respectively through the cooler and the water separator, the first and the second adsorption dryer.

28. An ejector-manifold for mixing compressed gas with a portion of cooled compressed gas according to a method according to claim 22

29. A compressor installation comprising a compressor with an outlet connected to the inlet of a device according to claim 16.
